(19) United States
(12) Patent Application Publication
(10) Pub. No.: US 2018/0368472 A1
(43) Pub. Date: Dec. 27, 2018

(54) ENCAPSULATED INGREDIENTS FOR E-VAPING DEVICES AND METHOD OF MANUFACTURING THEREOF

(71) Applicant: Altria Client Services LLC, Richmond, VA (US)

(72) Inventors: Munmaya K. Mishra, Manakin Sabot, VA (US); Shaoyong Yu, Glen Allen, VA (US); Pauline Marcq, Richmond, VA (US); Christian Schuh, Mechanicsville, VA (US); Yu Fang, Midlothian, VA (US); Eric A. Hawes, Midlothian, VA (US); Gerd Kobal, Sandy Hook, VA (US)

(73) Assignee: Altria Client Services LLC, Richmond, VA (US)

(21) Appl. No.: 15/628,964

(22) Filed: Jun. 21, 2017

(51) Int. Cl. A24F 47/00; A24B 15/16; H05B 1/02; H05B 3/44; F22B 1/28

(52) U.S. Cl. CPC A24F 47/008; A24B 15/167; F22B 1/284; H05B 3/44; H05B 1/0297

(57) ABSTRACT

An e-vaping device including a cartridge, a power source, a mouth-end insert, and at least one removable segment removably attached to at least one of the cartridge, the power source, another removable segment, and the mouth-end insert. A method of preparing an ingredient matrix including providing a plurality of pellets of a matrix material in a sealed container and adding in the sealed container at least one of a flavorant, a taste compound, an aroma, an acid, a vapor former, tobacco and nicotine. The at least one of a flavorant, taste compound, aroma, acid, and nicotine being absorbed by the plurality of pellets of the matrix material.

### BACKGROUND OF THE INVENTION

### Field of the Invention

Example embodiments relate generally to encapsulated ingredients used in an e-vaping device, and/or a manufacturing method thereof.

### Related Art

Electronic vaping devices are used to vaporize a pre-vapor formulation into a vapor. These electronic vaping devices may be referred to as e-vaping devices. An e-vaping device may typically include several e-vaping elements such as a power supply section and a cartridge or tank. The power supply section includes a power source such as a battery, and the cartridge includes a heater along with a reservoir capable of holding the pre-vapor formulation, the cartridge including a conduit such as a chimney that conveys the vapor through the device during operation. The heater in the cartridge is in contact with the pre-vapor formulation via a wick, and is configured to heat the pre-vapor formulation to generate a vapor. The heater may be intertwined with the wick. The pre-vapor formulation typically includes nicotine and optionally other ingredients such as acids, propylene glycol, glycerol or flavorants. For example, the pre-vapor formulation may include a liquid, solid and/or gel formulation including, but not limited to, water, beads, solvents, active ingredients, ethanol, plant extracts, natural or artificial flavors, and/or vapor formers such as glycerin and/or propylene glycol.

In other e-vaping devices, adding flavorants or aromas is typically performed by adding the flavorants or aromas to the storage container. However, if one or more flavorants or aromas react with other ingredients of the pre-vapor formulation in such a manner as to decrease the shelf life of the pre-vapor formulation, degradation of the pre-vapor formulation, or degradation of the flavorants, taste compounds and aromas, may occur as a result.

### SUMMARY OF THE INVENTION

At least one example embodiment relates to a segment, for example a removable segment, of an e-vaping device.

At least one example embodiment relates to a segment, for example a fixed segment, of an e-vaping device.

At least one example embodiment relates to an e-vaping device including a cartridge, a power source, a mouth-end insert, and at least one removable segment.

At least one example embodiment relates to a method of preparing an ingredient matrix for an e-vaping device.

Example embodiments relate to a removable segment of an e-vaping device including at least one matrix, and one of at least one flavorant, at least one taste compound, at least one aroma, at least one acid, or nicotine embedded or encapsulated in the matrix, the removable segment being removably attachable to at least one of a cartridge, another removable segment, and a mouth-end insert of the e-vaping device via at least one connector.

Example embodiments relate to a fixed segment of an e-vaping device including at least one matrix, and one of at least one flavorant, at least one taste compound, at least one aroma, at least one acid, or nicotine embedded or encapsulated in the matrix, the fixed segment being fixedly attachable to at least one of a cartridge, a removable segment, and a mouth-end insert of the e-vaping device via at least one connector.

Example embodiments relate to an e-vaping device including a cartridge, a power source, a mouth-end insert, and at least one removable segment removably attached to at least one the cartridge, the power source, another removable segment, and the mouth-end insert.

Example embodiments relate to a method of preparing an ingredient matrix for an e-vaping device, the method including providing a matrix including a plurality of pellets in a sealed container, and adding at least one a flavorant, a taste compound, an aroma, an acid, and nicotine in the sealed container, the at least one flavorant taste compound, aroma, acid, and nicotine being absorbed by the plurality of pellets of the matrix material. Alternatively, the matrix may be or include a single porous portion. For example, adding the at least one flavorant, taste compound, aroma, acid, and nicotine may include adding, by injecting or mixing, the at least one flavorant, taste compound, aroma, acid, and nicotine. In some example embodiments, the matrix includes sheets of paper such as cellulosic material, cellulose-based material or polymer and cellulose blend in the form of, for example, cellulose paper or blotting paper. For example, the matrix may include shredded sheets of paper, or a sponge-like matrix of cellulose having various thicknesses.

In example embodiments, the matrix includes a plurality of pellets including at least one of starch, cellulosic material, cellulose-based material or polymer and cellulose blend, and fibers. In example embodiments, the matrix includes sheets, or shredded sheets, of at least one of starch, cellulosic material, cellulose-based material or polymer and cellulose blend, and fibers.

In example embodiments, the matrix includes tobacco encapsulated in the beads, the beads including, or being made of, at least one of starch, cellulosic material, cellulose-based material or polymer and cellulose blend, and fibers. Accordingly, the tobacco may provide tobacco flavoring in combination with the nicotine and any flavorants, which may increase the sensory experience of the adult vaper. Some example embodiments relate to hybrid formulations including both tobacco and a pre-vapor formulation having, for example, propylene glycol, glycerin, aromas, flavorants and nicotine.

In example embodiments, the at least one flavorant, taste compound, aroma, acid, and nicotine are absorbed by the plurality of pellets.

In example embodiments, the plurality of pellets include at least one of a flavorant absorbed by at least one first pellet, a taste compound absorbed by at least one second pellet, an aroma absorbed by at least one third pellet, an acid absorbed by at least one fourth pellet, and nicotine absorbed by at least one fifth pellet.

In example embodiments, the at least one first pellet, second pellet and/or third pellet are in a portion of the removable segment that is closest to the mouth-end insert when the removable segment is attached to the e-vaping device. Alternatively, the at least one first pellet, second pellet and/or third pellet are in a portion of a fixed segment that is closest to the mouth-end insert when the fixed segment is attached to the e-vaping device.

In example embodiments, the plurality of pellets are porous and are stabilized or kept together in the matrix via a stabilizing agent, where the stabilizing agent may include a gel. In other example embodiments, the plurality of pellets are porous and stabilized in the matrix without a stabilizing agent.

In example embodiments, the at least one of the fourth pellet and the fifth pellet is in a portion of the removable segment that is farthest to the mouth-end insert when the removable segment is attached to the e-vaping device.

In example embodiments, the at least one removable segment is removably attached to the at least one of the cartridge, the power source, the mouth-end insert, and the other removable segment via a connector, and the connector includes one of a male connector and a female connector, the male connector and the female connector being in a mating configuration with a counterpart connector of at least one of the cartridge, the other container, and the mouth-end insert of the e-vaping device.

Example embodiments relate to an e-vaping device that includes a cartridge, a power source, a mouth-end insert, and at least one removable segment removably attached to at least one the cartridge, the power source, another removable segment, and the mouth-end insert.

In example embodiments, the cartridge includes at least one of a vapor former and water. In other example embodiments, the cartridge does not include a vapor former, or does not include water.

Example embodiments relate to a method of preparing an ingredient matrix for an e-vaping device including providing a matrix including a plurality of pellets in a sealed container, and adding at least one of a flavorant, a taste compound, an aroma, an acid, and nicotine in the sealed container, the at least one flavorant, taste compound, aroma, acid, and nicotine being absorbed by the plurality of pellets.

In some example embodiments, the devices discussed below may include e-vaping devices having a tobacco portion that includes tobacco.

In example embodiments, adding the flavorant, taste compound or aroma results in about 1% to about 40%, for example about 1% to about 5%, flavorant in the matrix material.

In example embodiments, adding the acid includes adding results in about 1% to about 30%, for example about 5% to about 10%, acid in the matrix material.

In example embodiments, adding the nicotine results in about 1% to about 50%, for example about 1% to about 10%, nicotine in the matrix material.

### BRIEF DESCRIPTION OF THE DRAWINGS

The above and other features and advantages of example embodiments will become more apparent by describing in detail, example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 is a side view of an e-vaping device, according to an example embodiment;

FIG. 2 is a longitudinal cross-sectional view of an e-vaping device, according to an example embodiment;

FIG. 3 is a longitudinal cross-sectional view of another example embodiment of an e-vaping device;

FIG. 4 is a longitudinal cross-sectional view of another example embodiment of an e-vaping device;

FIG. 5 illustrates an e-vaping device with a tank in accordance with an example embodiment;

FIG. 6 is a flow chart illustrating a method of preparing an ingredient matrix for an e-vaping device, according to at least one example embodiment;

FIG. 7 is an illustration of a plurality of pellets, according to at least one example embodiment;

FIGS. 8(a)-(c) are illustrations of a removable segment for an e-vaping device, according to at least one example embodiment;

FIG. 9 is a side view of an e-vaping device, according to an example embodiment;

FIG. 10 illustrates an example mouth-end insert for an e-vaping device in accordance with an example embodiment; and

FIG. 11 is an illustration of a removable segment for an e-vaping device, according to at least one example embodiment.

### DETAILED DESCRIPTION

Some detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein. For example, the devices discussed below may include e-vaping devices that include a tobacco portion that includes tobacco.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It should be understood that when an element or layer is referred to as being “on,” “connected to,” “coupled to,” or “covering” another element or layer, it may be directly on, connected to, coupled to, or covering the other element or layer or intervening elements or layers may be present. In contrast, when an element is referred to as being “directly on,” “directly connected to,” or “directly coupled to” another element or layer, there are no intervening elements or layers present. Like numbers refer to like elements throughout the specification. As used herein, the term “and/or” includes any and all combinations of one or more of the associated listed items.

It should be understood that, although the terms “first,” “second,” “third,” etc. may be used herein to describe various elements, regions, layers and/or sections, these elements, regions, layers, and/or sections should not be limited by these terms. These terms are only used to distinguish one element, region, layer, or section from another region, layer, or section. Thus, a first element, region, layer, or section discussed below could be termed a second element, region, layer, or section without departing from the teachings of example embodiments.

Spatially relative terms (e.g., “beneath,” “below,” “lower,” “above,” “upper,” and the like) may be used herein for ease of description to describe one element or feature's relationship to another element(s) or feature(s) as illustrated in the figures. It should be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various embodiments only and is not intended to be limiting of example embodiments. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations and/or elements, but do not preclude the presence or addition of one or more other features, integers, steps, operations, elements and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the shapes of regions illustrated herein but are to include deviations in shapes that result, for example, from manufacturing. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

When the terms “about” or “substantially” are used in this specification in connection with a numerical value, it is intended that the associated numerical value include a tolerance of ±10% around the stated numerical value. Moreover, when reference is made to percentages in this specification, it is intended that those percentages are based on weight, i.e., weight percentages. The expression “up to” includes amounts of zero to the expressed upper limit and all values therebetween. When ranges are specified, the range includes all values therebetween such as increments of 0.1%.

As used herein, the term “vapor former” describes any suitable known compound or mixture of compounds that, in use, facilitates formation of a vapor and that is substantially resistant to thermal degradation at the operating temperature of the e-vaping device. Suitable vapor-formers consist of various compositions of polyhydric alcohols such as propylene glycol and/or glycerol or glycerin. In at least one embodiment, the vapor former is propylene glycol.

FIG. 1 is a side view of an e-vaping device 60, according to an example embodiment. In FIG. 1, the e-vaping device 60 includes a first section or cartridge 70 and a second section or power supply section 72, which are coupled together at a threaded joint 74 or by other connecting structure such as a snug-fit, snap-fit, detent, clamp and/or clasp or the like. In at least one example embodiment, the first section or cartridge 70 may be a replaceable cartridge, and the second section 72 may be a reusable section. Alternatively, the first section or cartridge 70 and the second section 72 may be integrally formed in one piece. In at least one embodiment, the second section 72 includes a LED at a distal end 28 thereof. In example embodiments, the first section may be or include a tank 70 configured to hold the pre-vapor formulation and to be manually refillable.

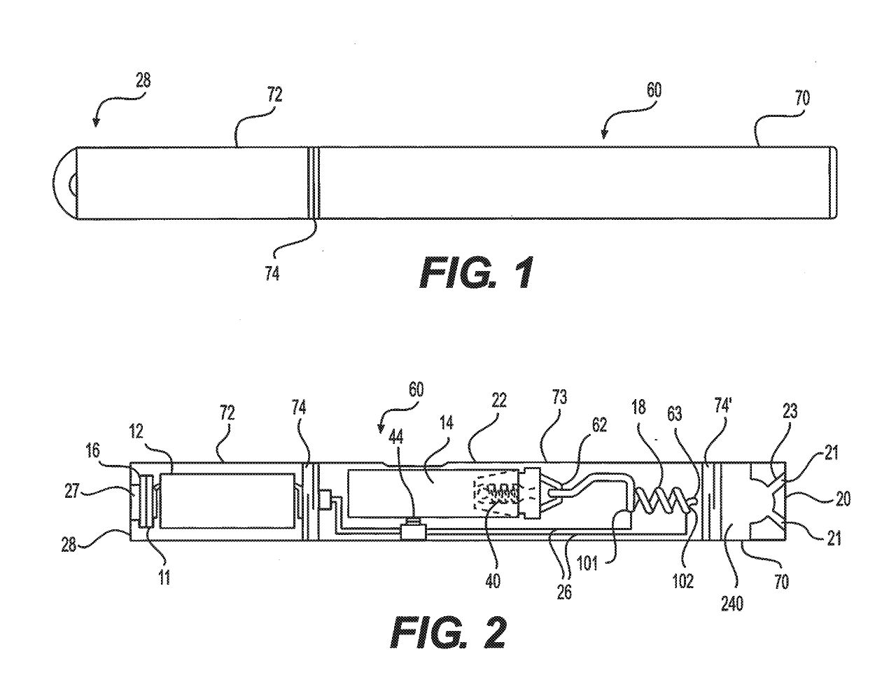

FIG. 2 is a cross-sectional view of an example embodiment of an e-vaping device. As shown in FIG. 2, the first section or cartridge 70 can house a mouth-end insert 20, a capillary tube 18, and a reservoir 14.

In example embodiments, the reservoir 14 may include a wrapping of gauze about an inner tube (not shown). For example, the reservoir 14 may be formed of or include an outer wrapping of gauze surrounding an inner wrapping of gauze. In at least one example embodiment, the reservoir 14 may be formed of or include an alumina ceramic in the form of loose particles, loose fibers, or woven or nonwoven fibers. Alternatively, the reservoir 14 may be formed of or include a cellulosic material such as cotton or gauze material, or a polymer material, such as polyethylene terephthalate, in the form of a bundle of loose fibers. A more detailed description of the reservoir 14 is provided below.

The second section 72 can house a power supply 12, control circuitry 11 configured to control the power supply 12, and a puff sensor 16. The puff sensor 16 is configured to sense when an adult vaper is drawing on the e-vaping device 60, which triggers operation of the power supply 12 via the control circuitry 11 to heat the pre-vapor formulation housed in the reservoir 14, and thereby form a vapor. A threaded portion 74 of the second section 72 can be connected to a battery charger, when not connected to the first section or cartridge 70, to charge the battery or power supply section 12.

In example embodiments, the capillary tube 18 is formed of or includes a conductive material, and thus may be configured to be its own heater by passing current through the tube 18. The capillary tube 18 may be any electrically conductive material capable of being heated, for example resistively heated, while retaining the necessary structural integrity at the operating temperatures experienced by the capillary tube 18, and which is non-reactive with the pre-vapor formulation. Suitable materials for forming the capillary tube 18 are one or more of stainless steel, copper, copper alloys, porous ceramic materials coated with film resistive material, nickel-chromium alloys, and combinations thereof. For example, the capillary tube 18 is a stainless steel capillary tube 18 and serves as a heater via electrical leads 26 attached thereto for passage of direct or alternating current along a length of the capillary tube 18. Thus, the stainless steel capillary tube 18 is heated by, for example, resistance heating. Alternatively, the capillary tube 18 may be a non-metallic tube such as, for example, a glass tube. In such an embodiment, the capillary tube 18 also includes a conductive material such as, for example, stainless steel, nichrome or platinum wire, arranged along the glass tube and capable of being heated, for example resistively. When the conductive material arranged along the glass tube is heated, pre-vapor formulation present in the capillary tube 18 is heated to a temperature sufficient to at least partially volatilize pre-vapor formulation in the capillary tube 18.

In at least one embodiment, the electrical leads 26 are bonded to the metallic portion of the capillary tube 18. In at least one embodiment, one electrical lead 26 is coupled to a first, upstream portion 101 of the capillary tube 18 and a second electrical lead 26 is coupled to a downstream, end portion 102 of the capillary tube 18.

In operation, the puff sensor 16 detects a pressure gradient caused by the drawing of the adult vaper on the e-vaping device, and the control circuitry 11 controls heating of the pre-vapor formulation located in the reservoir 14 by providing power to the capillary tube 18. Once the capillary tube 18 is heated, the pre-vapor formulation contained within a heated portion of the capillary tube 18 is volatilized and emitted from the outlet 63, where the pre-vapor formulation expands and mixes with air and forms a vapor in mixing chamber 240.

As shown in FIG. 2, the reservoir 14 includes a valve 40 configured to maintain the pre-vapor formulation within the reservoir 14 and to open when the reservoir 14 is squeezed and pressure is applied thereto, the pressure being created when an adult vaper draws on the e-vaping device at the mouth-end insert 20, which results in the reservoir 14 forcing the pre-vapor formulation through the outlet 62 of the reservoir 14 to the capillary tube 18. In at least one embodiment, the valve 40 opens when a critical, minimum pressure is reached so as to avoid inadvertently dispensing pre-vapor formulation from the reservoir 14. In at least one embodiment, the pressure required to press the pressure switch 44 is high enough such that accidental heating due to the pressure switch 44 being inadvertently pressed by outside factors such as physical movement or collision with outside objects is avoided.

The power supply 12 of example embodiments can include a battery arranged in the second section 72 of the e-vaping device 60. The power supply 12 is configured to apply a voltage to volatilize the pre-vapor formulation housed in the reservoir 14.

In at least one embodiment, the electrical connection between the capillary tube 18 and the electrical leads 26 is substantially conductive and temperature resistant while the capillary tube 18 is substantially resistive so that heat generation occurs primarily along the capillary tube 18 and not at the contacts.

The power supply section or battery 12 may be rechargeable and include circuitry allowing the battery to be chargeable by an external charging device. In example embodiments, the circuitry, when charged, provides power for a given number of draws through outlets of the e-vaping device, after which the circuitry may have to be re-connected to an external charging device.

In at least one embodiment, the e-vaping device 60 may include control circuitry 11 which can be, for example, on a printed circuit board. The control circuitry 11 may also include a heater activation light 27 that is configured to glow when the device is activated. In at least one embodiment, the heater activation light 27 comprises at least one LED and is at a distal end 28 of the e-vaping device 60 so that the heater activation light 27 illuminates a cap which takes on the appearance of a burning coal when the adult vaper draws on the e-vaping device. Moreover, the heater activation light 27 can be configured to be visible to the adult vaper. The light 27 may also be configured such that the adult vaper can activate and/or deactivate the light 27 when desired, such that the light 27 is not activated during vaping if desired.

In at least one embodiment, the e-vaping device 60 further includes a mouth-end insert 20 having at least two off-axis, diverging outlets 21 that are uniformly distributed around the mouth-end insert 20 so as to substantially uniformly distribute vapor in the mouth of an adult vaper during operation of the e-vaping device. In at least one embodiment, the mouth-end insert 20 includes at least two diverging outlets 21 (e.g., 3 to 8 outlets or more). In at least one embodiment, the outlets 21 of the mouth-end insert 20 are located at ends of off-axis passages 23 and are angled outwardly in relation to the longitudinal direction of the e-vaping device 60 (e.g., divergently). As used herein, the term “off-axis” denotes an angle to the longitudinal direction of the e-vaping device.

In at least one embodiment, the e-vaping device 60 is about the same size as a tobacco-based product. In some embodiments, the e-vaping device 60 may be about 80 mm to about 110 mm long, for example about 80 mm to about 100 mm long and about 7 mm to about 10 mm in diameter.

The outer cylindrical housing 22 of the e-vaping device 60 may be formed of or include any suitable material or combination of materials. In at least one embodiment, the outer cylindrical housing 22 is formed at least partially of metal and is part of the electrical circuit connecting the control circuitry 11, the power supply 12 and the puff sensor 16.

As shown in FIG. 2, the e-vaping device 60 can also include a middle section (third section) 73, which can house the pre-vapor formulation reservoir 14 and the capillary tube 18. The middle section 73 can be configured to be fitted with a threaded joint or portion 74 at an upstream end of the first section or cartridge 70 and a threaded joint 74 at a downstream end of the second section 72. In this example embodiment, the first section or cartridge 70 houses the mouth-end insert 20, while the second section 72 houses the power supply 12 and the control circuitry 11 that is configured to control the power supply 12.

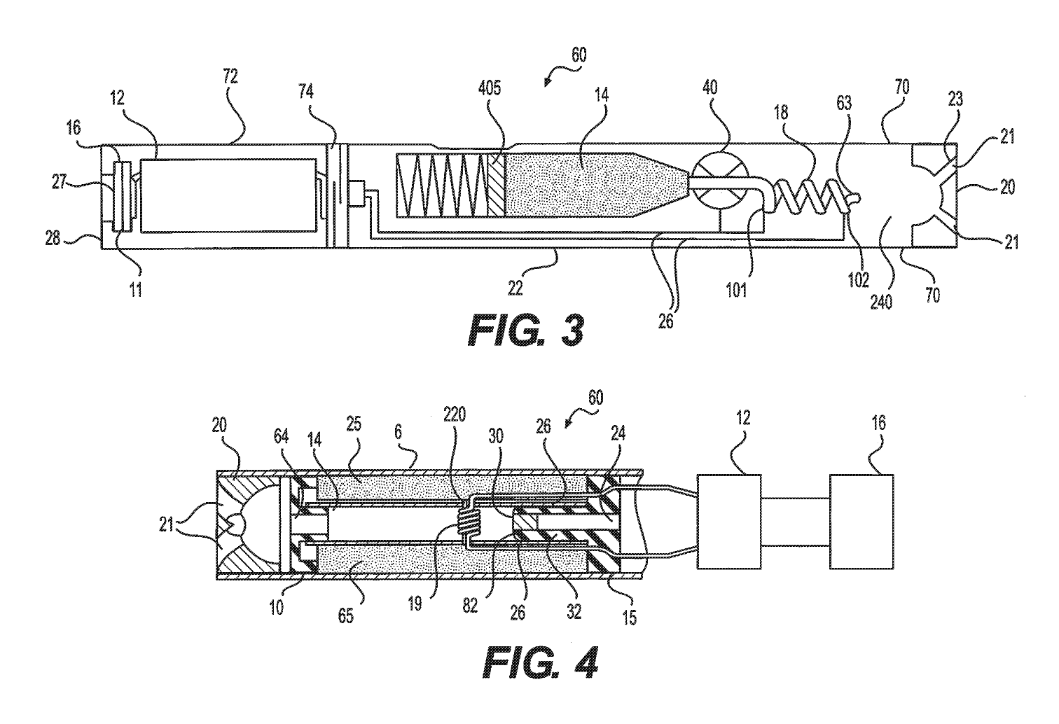

FIG. 3 is a cross-sectional view of an e-vaping device according to an example embodiment. In at least one embodiment, the first section or cartridge 70 is replaceable so as to avoid the need for cleaning the capillary tube 18. In at least one embodiment, the first section or cartridge 70 and the second section 72 may be integrally formed without threaded connections to form a disposable e-vaping device.

As shown in FIG. 3, in other example embodiments, a valve 40 can be a two-way valve, and the reservoir 14 can be pressurized. For example, the reservoir 14 can be pressurized using a pressurization arrangement 405 configured to apply constant pressure to the reservoir 14. As such, emission of vapor formed via heating of the pre-vapor formulation housed in the reservoir 14 is facilitated. Once pressure upon the reservoir 14 is relieved, the valve 40 closes and the heated capillary tube 18 discharges any pre-vapor formulation remaining downstream of the valve 40.

FIG. 4 is a longitudinal cross-sectional view of another example embodiment of an e-vaping device. In FIG. 4, the e-vaping device 60 can include a central air passage 24 in an upstream seal 15. The central air passage 24 opens to the inner tube 65. Moreover, the e-vaping device 60 includes a reservoir 14 configured to store the pre-vapor formulation. The reservoir 14 includes the pre-vapor formulation and optionally a storage medium 25 such as gauze configured to store the pre-vapor formulation therein. In an embodiment, the reservoir 14 is contained in an outer annulus between the outer tube 6 and the inner tube 65. The annulus is sealed at an upstream end by the seal 15 and by a stopper 10 at a downstream end so as to prevent leakage of the pre-vapor formulation from the reservoir 14. The heater 19 at least partially surrounds a central portion of a wick 220 such that when the heater is activated, the pre-vapor formulation present in the central portion of the wick 220 is vaporized to form a vapor. The heater 19 is connected to the battery 12 by two spaced apart electrical leads 26. The e-vaping device 60 further includes a mouth-end insert 20 having at least two outlets 21. The mouth-end insert 20 is in fluid communication with the central air passage 24 via the interior of inner tube 65 and a central passage 64, which extends through the stopper 10.

The e-vaping device 60 may include an air flow diverter comprising an impervious plug 30 at a downstream end 82 of the central air passage 24 in seal 15. In at least one example embodiment, the central air passage 24 is an axially extending central passage 24 in seal 15, which seals the upstream end of the annulus between the outer and inner tubes 6, 65. The radial air channel 32 directing air from the central passage 24 outward toward the inner tube 65. In operation, when an adult vaper draws on the e-vaping device, the puff sensor 16 detects a pressure gradient caused by the drawing of the adult vaper, and as a result the control circuitry 11 controls heating of the pre-vapor formulation located in the reservoir 14 by providing power the heater 19.

In various example embodiments, a mouth-end insert similar to or the same as the mouth-end insert 20 discussed above, may be provided at an end of a cigarette or cigar. The adult smoker may taste various flavors when smoking the cigarette or cigar with the mount-end insert.

In some example embodiments, when the e-vaping device includes a tank (not shown) instead of the cartridge 70, the e-vaping tank generally includes a pre-vapor formulation reservoir that is unsealed, and may essentially be an empty vessel that allows for manual refilling. Similar to the cartridge, the heater 19 may communicate with a chimney that may be positioned within the tank. The heater 19 may be in fluid communication with the reservoir via the wick (or other structure offering a capillary action) 220, for instance. Unlike the cartridge 70, the reservoir of the e-vaping tank may be unsealed. Therefore, once the pre-vapor formulation from the reservoir is depleted, at least a portion of the reservoir may be accessed in order to allow the reservoir to be manually filled again with the pre-vapor formulation.

In some example embodiments, the cartridge of the electronic device may include one or more vapor precursor pods (not shown), and may be configured to store/charge the e-vapor device while also, for example, displaying battery level information. The e-vapor device may also be configured to receive, hold, and puncture one or more of the precursor pods to access the vapor formulation enclosed therein. After vaping, the used vapor precursor pod(s) may be discarded via a press/release mechanism. Once the vapor precursor pod(s) in the cartridge has (have) been used, the cartridge 70 of the e-vapor device may be discarded and replaced.

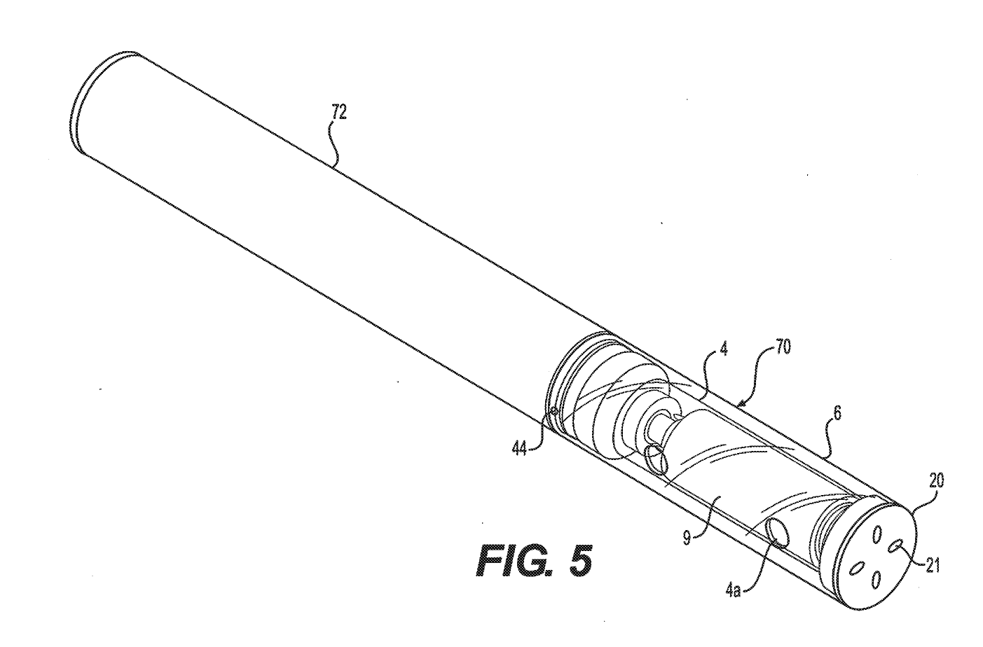

FIG. 5 illustrates an e-vaping device with a tank 70, in accordance with an example embodiment. In the example embodiment, a power section 72 may be connected to the cartridge 70. The device may also include a mouth-end insert 20 having at a plurality of outlets 21, as discussed above with respect to FIG. 3.

In this example embodiment, either the outer tube 6, or both the outer tube 6 and the inner tube 4, may be or include a transparent or translucent material. The transparent and/or translucent material may be made from glass, acrylic, polycarbonate, quartz, silica, or other suitable materials that allows for the internals of the cartridge 70 to be viewed. In particular, the transparent and/or translucent nature of the outer tube 6 (or the outer tube 6 and inner tube 4) may allow a remaining level of the pre-vapor formulation to be determined.

It should be noted that, with the existence of the gauze layers 9, and especially with regard to a relatively thick layer of gauze 9, the cartridge 70 may appear to be devoid of visible amounts of the pre-vapor formulation toward an end of a useful-life of the cartridge 70. However, given the absorptive qualities of the gauze 9, the cartridge 70 may continue to successfully operate for a fairly extended period of time despite a lack of any visible presence of the pre-vapor formulation.

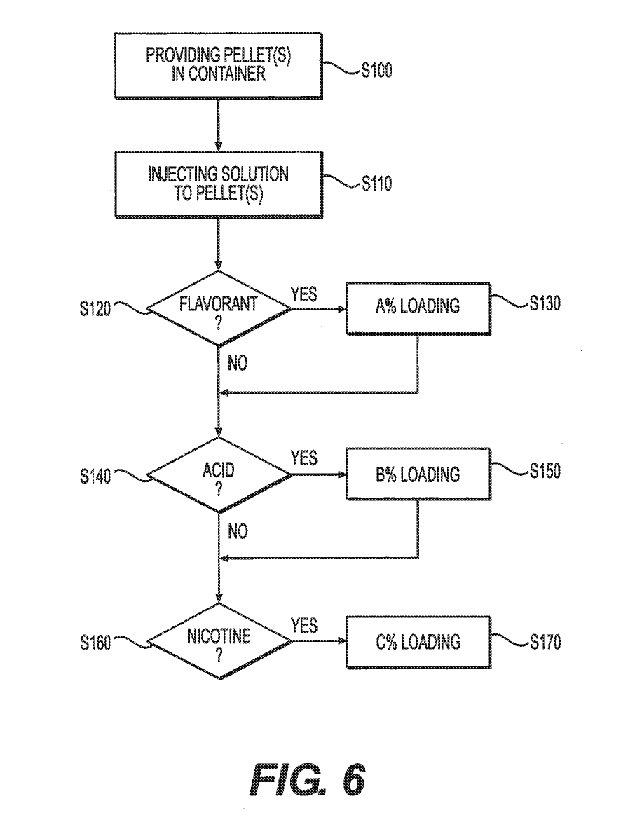

FIG. 6 is a flow chart illustrating a method of preparing an ingredient matrix for an e-vaping device, according to at least one example embodiment. In FIG. 6, at S100, one or more pellets are provided in a container, for example, a sealed container. The pellets may be made of or include, for example, at least one of starch, cellulosic material, cellulose-based material or polymer and cellulose blend, and one or more fibers. At S110, a solution is added in the container. The solution may include, for example, one of a flavorant, an aroma, an acid, nicotine, or a combination thereof as desired. In example embodiments, suitable flavorants can include, but are not limited to, menthol, mint, such as peppermint and spearmint, chocolate, licorice, citrus and other fruit flavors, gamma octalactone, vanillin, ethyl vanillin, breath freshener flavors, spice flavors such as cinnamon, methyl salicylate, linalool, bergamot oil, geranium oil, lemon oil, ginger oil, and tobacco flavor, tea flavor, wine flavor, berry flavor, coffee flavor, etc. Other suitable flavors may include flavor compounds selected from the group consisting of an acid, an alcohol, an ester, an aldehyde, a ketone, a pyrazine, combinations or blends thereof and the like.

At S120, if the solution is made of or include a flavorant or an aroma, then the method continues to S130 where the amount of solution is added so that the concentration of flavorant in the pellets is about a %, “a” being, for example, about 1% to about 40%, or for example about 1% to about 7%. In example embodiments, “a” may range between about 3% and about 7%, with intervals of about 0.5%. Accordingly, “a” may be equal to about 3%, 3.5%, 4%, 4.5%, 5%, 5.5%, 6%, 6.5% and 7%. If at S120, the solution does not include a flavorant or an aroma, or after the loading step S130 is completed, the method continues to S140. At S140, if the solution is made of or includes an acid, then the method continues to S150, where the amount of solution is added so that the concentration of acid in the pellets is about b %, “b” being about 10%. In example embodiments, “b” may be about 1% to about 30%, for example about 5% to about 10%, or may range between about 7% and about 13%, with intervals of about 0.5%. Accordingly, “b” may be equal to about 7%, 7.5%, 8%, 8.5%, 9%, 9.5%, 10%, 10.5%, 11%, 11.5%, 12%, 12.5% and 13%. Suitable acids may include, for example, one or more of formic acid, oxalic acid, glycolic acid, acetic acid, isovaleric acid, valeric acid, propionic acid, octanoic acid, lactic acid, sorbic acid, malic acid, tartaric acid, succinic acid, citric acid, benzoic acid, oleic acid, aconitic acid, butyric acid, cinnamic acid, decanoic acid, 3,7-dimethyl-6-octenoic acid, 1-glutamic acid, heptanoic acid, hexanoic acid, 3-hexenoic acid, trans-2-hexenoic acid, isobutyric acid, lauric acid, 2-methylbutyric acid, 2-methylvaleric acid, myristic acid, nonanoic acid, palmitic acid, 4-pentenoic acid, phenylacetic acid, 3-phenylpropionic acid, hydrochloric acid, phosphoric acid and sulfuric acid.

If at S140 the solution does not include an acid, or after the loading step S150 is completed, the method continues to S160. At S160, if the solution is made of or include nicotine, the amount of solution is added at S170 so that the concentration of nicotine in the pellets is about c %, “c” being about 15%. In example embodiments, “c” may be about 1% to about 50%, for example about 1% to about 10%, or may range between about 11% and about 19%, with intervals of about 0.5%. Accordingly, “c” may be equal to about 11%, 11.5%, 12%, 12.5%, 13%, 13.5%, 14%, 14.5%, 15%, 15.5%, 16%, 16.5%, 17%, 17.5%, 18%, 18.5% and 19%.

According to various example embodiments, although steps S120, S140 and S160 are described in a sequential manner, these steps are discussed by way of example and should not limit the scope of the invention as they may be performed in any suitable order.

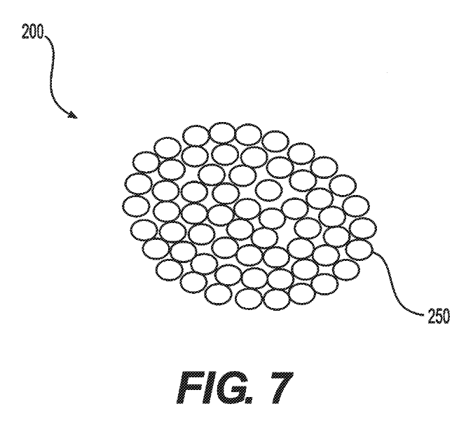

FIG. 7 is an illustration of an ingredient matrix, according to at least one example embodiment. In FIG. 7, the ingredient matrix 200 is composed of or include a plurality of pellets 250. In example embodiments, the pellets 250 are aggregated together via pressure applied during the manufacturing process of the ingredient matrix 200. For example, there may not be a ligand or gel to coalesce or aggregate the plurality of pellets 250. The pellets may be made of or include, for example, starch, cellulosic material, cellulose-based material or polymer and cellulose blend, and/or fibers. In other example embodiments, a ligand or gel may be present in the ingredient matrix 200 to coalesce or aggregate the plurality of pellets 250. The gel may be made via, for example, a gelling polymer. Examples of a gelling polymer may be water soluble carbohydrates such as, for example, agar, hydroxyethyl cellulose and gelan.

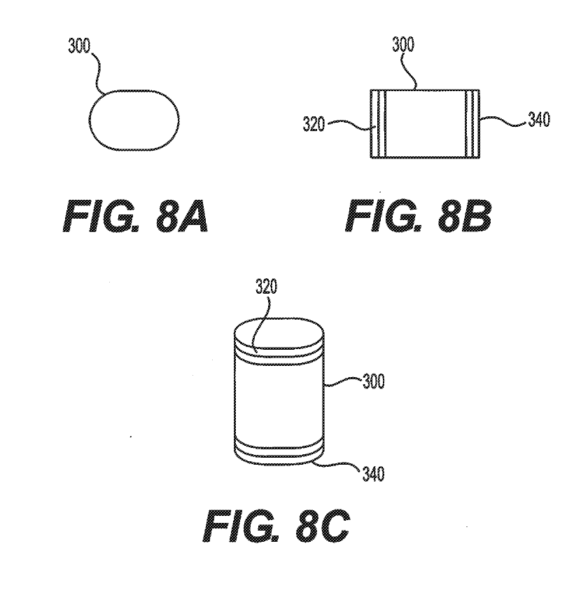

FIGS. 8(a)-(c) are illustrations of a segment, for example a removable segment for an e-vaping device, according to at least one example embodiment. FIG. 8(a) is a top view of removable segment 300. In example embodiments, the circumference of the removable segment 300 may be substantially circular. In example embodiments, the removable segment 300 has a same or similar circumference shape and/or size as the cartridge of the e-vaping device to which the removable segment 300 is configured to be removably attached to be attachable to the cartridge of the e-vaping device. FIG. 8(b) is a side view of the removable segment 300, the removable segment 300 including a connector 320 and a connector 340 at each end thereof, the connectors 320 and 340 being configured to removably attach the removable segment 300 to the cartridge and the mouth-end insert, respectively, or to one or more other removable segments of the e-vaping device. FIG. 8(c) is a perspective view of the removable segment 300, according to various example embodiments. In FIG. 8(c), the removable segment 300 includes the connectors 320 and 340 that are configured to removably attach the removable segment 300 to the cartridge and the mouth-end insert, respectively, or to one or more other removable segments of the e-vaping device. In some example embodiments, the segment 300 is a fixed segment.

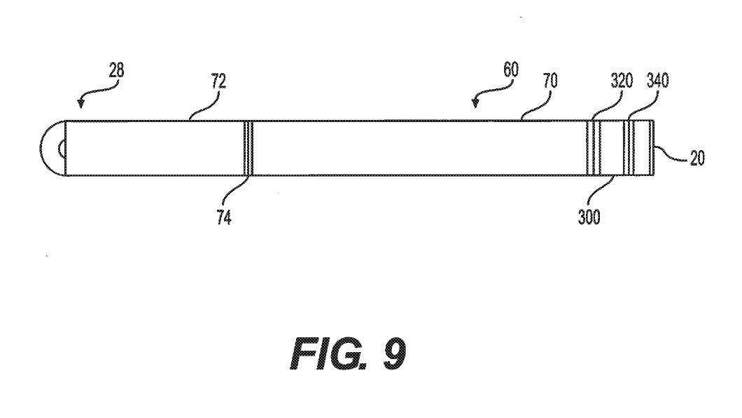

FIG. 9 is a side view of an e-vaping device, according to an example embodiment. In FIG. 9, similarly to FIG. 1, the e-vaping device 60 includes a first section or cartridge 70 and a second section or power supply section 72, which are coupled together at a threaded joint 74. In at least one example embodiment, the first section or cartridge 70 may be a replaceable cartridge, and the second section 72 may be a reusable section. In some example embodiments, a segment such as a removable segment 300 is inserted between the first section/cartridge 70 and the mouth-end insert 20, the removable segment 300 having a same or similar circumference shape and/or size as the cartridge 70 and the mouth-end insert 20, and including connectors 320 and 340 at each end thereof. The removable segment 300 is connected to the cartridge 70 and to the mouth-end insert 20 via the connectors 320 and 340, respectively. In some example embodiments, the segment 300 is a fixed segment.

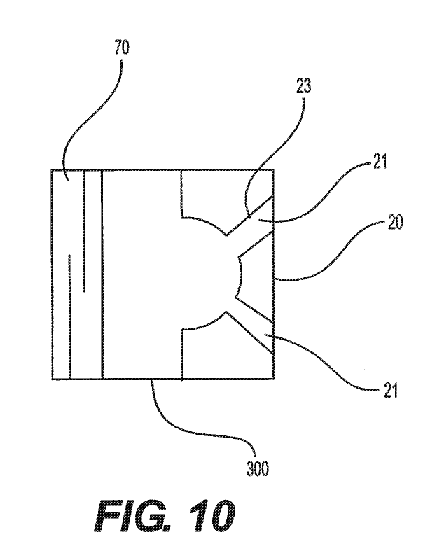

FIG. 10 illustrates a mouth-end insert for an e-vaping device in accordance with an example embodiment. In FIG. 10, the removable segment 300 is inserted between the mouth-end insert 20 and the first section/cartridge 70. In some example embodiments, the removable segment 300 is configured to be removably attached to the mouth-end insert 20 and to the first section/cartridge 70 via connectors (not shown).

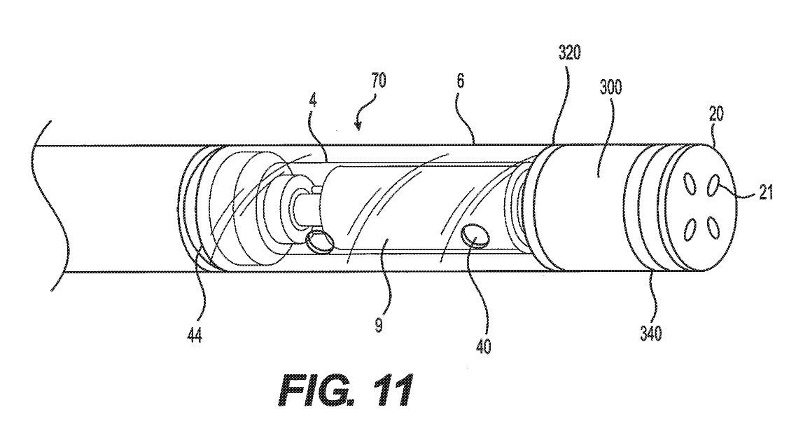

FIG. 11 is an illustration of a removable segment for an e-vaping device, according to at least one example embodiment. FIG. 11 illustrates an e-vaping device with a tank 70, in accordance with an example embodiment. In the example embodiment, the e-vaping device may include a mouth-end insert 20 having at a plurality of outlets 21, as discussed above with respect to FIG. 5. In some example embodiments, a removable segment 300 is inserted between the mouth-end insert 20 and the tank 70. In some example embodiments, the removable segment 300 is configured to be removably attached to the mouth-end insert 20 and to the tank 70 via connectors 340 and 320, respectively.

In operation, when the adult vaper draws on the e-vaping device, thereby creating a negative pressure that draws the vapor from the cartridge to the mouth-end insert, the vapor is transferred through the removable segment 300 and becomes impregnated by the various flavorants, aromas, acids and/or nicotine that are encapsulated in the segment 300. As a result, the vapor includes the taste and strength requirements for an enjoyable vaping experience by the adult vaper.

Example embodiments having thus been described, it will be obvious that the same may be varied in many ways. Such variations are not to be regarded as a departure from the intended spirit and scope of example embodiments, and all modifications as would be obvious to one skilled in the art are intended to be included within the scope of the following claims.

1. A removable segment of an e-vaping device, the removable segment comprising:
a matrix; and
at least one of a flavorant, a taste compound, an aroma, an acid, a vapor former, tobacco, nicotine encapsulated in the matrix, a sub-combination thereof, or a combination thereof;
the removable segment being removably attachable to at least one of a cartridge, another removable segment, a power source, a mouth-end insert of the e-vaping device, a sub-combination thereof, or a combination thereof.

2. The segment of claim 1, wherein the matrix comprises a plurality of pellets including at least one of starch, cellulose-based material, fibers, a sub-combination thereof, or a combination thereof.

3. The segment of claim 2, wherein the plurality of pellets are porous and are stabilized in the matrix via a stabilizing agent.

4. The segment of claim 3, wherein the stabilizing agent comprises a gel.

5. The segment of claim 2, wherein the plurality of pellets are porous and stabilized in the matrix without a stabilizing agent.

6. The segment of claim 2, wherein the at least one flavorant, taste compound, aroma, acid, vapor former, tobacco, nicotine, sub-combination thereof, or combination thereof, are absorbed by the plurality of pellets.

7. The segment of claim 6, wherein the plurality of pellets comprise at least one of:
a flavorant absorbed by at least one first pellet;
a taste compound absorbed by at least one second pellet;
an aroma absorbed by at least one third pellet;
an acid absorbed by at least one fourth pellet;
nicotine absorbed by at least one fifth pellet;
tobacco absorbed by at least one sixth pellet;
a sub-combination thereof; or
a combination thereof.

8. The segment of claim 7, wherein:
at least one of the first pellet, the second pellet, the third pellet, a sub-combination thereof, or a combination thereof, is in a portion of the removable segment that is closest to the mouth-end insert when the removable segment is attached to the e-vaping device.

9. The segment of claim 7, wherein the fourth pellet is in the portion of the removable segment that is farthest to the mouth-end insert.

10. The segment of claim 1, wherein the at least one removable segment is removably attached to the at least one of the cartridge, the power source, the mouth-end insert, the other removable segment, the sub-combination thereof, or the combination thereof, via a connector.

11. The segment of claim 10, wherein the connector includes at least one of a male connector, a female connector, or both the male connector and the female connector, the male connector and the female connector being in a mating configuration with a counterpart connector of the at least one of the cartridge, the power source, the mouth-end insert, the other removable segment, the sub-combination thereof, or the combination thereof.

12. An e-vaping device, comprising:
a cartridge;
a power source;
a mouth-end insert; and
at least one segment removably attached to at least one of the cartridge, the power source, the mouth-end insert, another removable segment, a sub-combination thereof, or a combination thereof.

13. The e-vaping device of claim 12, wherein the cartridge includes one of a vapor former, water or both the vapor former and water.

14. The e-vaping device of claim 12, wherein the at least one segment includes:
a matrix; and
at least one of a flavorant, a taste compound, an aroma, an acid, a vapor former, tobacco, nicotine, a sub-combination thereof, or a combination thereof, encapsulated in the matrix.

15. The e-vaping device of claim 14, wherein the matrix includes a plurality of pellets.

16. The e-vaping device of claim 15, wherein:
the plurality of pellets are porous; and
the at least one of the flavorant, taste compound, aroma, acid, vapor former, tobacco, nicotine, sub-combination thereof, or combination thereof, are absorbed by one or more of the plurality of pellets.

17. A method of preparing an ingredient matrix for an e-vaping device, the method comprising:
providing a matrix including a plurality of pellets in a sealed container; and
adding at least one of a flavorant, a taste compound, an aroma, an acid, a vapor former, tobacco, nicotine, a sub-combination thereof, or a combination thereof, in the sealed container;
the at least one of the flavorant, taste compound, aroma, acid, vapor former, tobacco, nicotine, sub-combination thereof, or combination thereof being absorbed by the plurality of pellets.

18. The method of claim 17, wherein the matrix comprises a matrix material including at least one of starch, cellulose-based material, fibers, a sub-combination thereof, or a combination thereof.

19. The method of claim 18, wherein at least one of:
the adding the flavorant results in about 1% to about 40% flavorant in the matrix material;
the adding the taste compound results in about 1% to about 40% taste compound in the matrix material;
the adding the aroma results in about 1% to about 40% aroma in the matrix material;
a sub-combination thereof; or
a combination thereof.

20. The method of claim 18, wherein one of:
the adding the acid results in about 1% to about 30% acid in the matrix material;
the adding the nicotine results in about 1% to about 50% nicotine in the matrix material; or
the adding the acid results in about 1% to about 30% acid in the matrix material and the adding the nicotine results in about 1% to about 50% nicotine in the matrix material.

21. A fixed segment of an e-vaping device, the fixed segment comprising:
a matrix; and
at least one of a flavorant, a taste compound, an aroma, an acid, a vapor former, tobacco, nicotine, a sub-combination thereof, or a combination thereof, encapsulated in the matrix;
the fixed segment being fixedly attached to at least one of a cartridge, a removable segment, a power source, a mouth-end insert, a sub-combination thereof, or a combination thereof, of the e-vaping device.

22. The segment of claim 7, wherein one of the fourth pellet, the fifth pellet, or both the fourth pellet and the fifth pellet, is in a portion of the removable segment that is farthest to the mouth-end insert when the removable segment is attached to the e-vaping device.
